(19) United States
(12) Patent Application Publication
(10) Pub. No.: US 2017/0277731 A1
(43) Pub. Date: Sep. 28, 2017

(54) HIDING NODES IN A TREE CONTAINING SHARED SUBTREES

(71) Applicant: International Business Machines Corporation, Armonk, NY (US)

(72) Inventors: Boris Melamed, Efrat (IL); Gideon Sireling, Jerusalem (IL)

(21) Appl. No.: 15/621,236

(22) Filed: Jun. 13, 2017

Related U.S. Application Data
(63) Continuation of application No. 15/082,223, filed on Mar. 28, 2016.

(51) Int. Cl. G06F 17/30

(52) U.S. Cl. CPC G06F 17/30303; G06F 17/30327; G06F 17/30958

(57) ABSTRACT

As disclosed herein a method determining whether a tree graph operation is a cutting operation. The method further includes, responsive to determining that the tree graph operation is a cutting operation, determining a cutting zone for the cutting operation, and identifying a developed node in the cutting zone that is to be retained in the tree graph, wherein the developed node is a root node of a shared subtree. The method further includes, responsive to determining the tree graph operation is not a cutting operation, attaching each child of the developed node to a parent of the developed node, and responsive to determining the developed node is a shared subtree with one or more children, attaching a reference to each child of the developed node to a parent of remaining undeveloped nodes. A computer program product and a computer system corresponding to the above method are also disclosed herein.

### BACKGROUND

The present invention relates to manipulating nodes in a tree graph, and more particularly to hiding shared subtrees in a tree graph.

With the development of technology in the computing industry, it has become relatively easy to gather and store vast amounts of information. The gathered information may be analyzed (e.g., using analytics) and presented to users as graphs using nodes and links between the nodes that represent the data The data presented in the graph may also be presented in a tree format, where the tree may use subtrees to represent duplicated data nodes within the tree without actually duplicating the data within the tree structure.

### SUMMARY

As disclosed herein a computer-implemented method includes receiving a tree graph operation, and determining whether the tree graph operation is a cutting operation. The method further includes, responsive to determining that the tree graph operation is a cutting operation, determining a cutting zone for the cutting operation, and identifying a developed node in the cutting zone that is to be retained in the tree graph subsequent to the cutting operation, wherein the developed node is a root node of a shared subtree. The method further includes, responsive to determining the tree graph operation is not a cutting operation, attaching each child of the developed node to a parent of the developed node, and responsive to determining the developed node is a shared subtree with one or more children, attaching a reference to each child of the developed node to a parent of remaining undeveloped nodes. The method further includes hiding each node of the tree graph that is to be hidden. A computer program product and a computer system corresponding to the above method are also disclosed herein.

### BRIEF DESCRIPTION OF THE DRAWINGS

FIG. 1 is a functional block diagram depicting a computing environment, in accordance with at least one embodiment of the present invention;

FIG. 2 is a flowchart depicting a tree manipulation method, in accordance with at least one embodiment of the present invention;

FIG. 3A depicts an example tree with a shared subtree, in accordance with at least one embodiment of the present invention;

FIG. 3B depicts an example tree after a non-cutting tree operation, in accordance with at least one embodiment of the present invention;

FIG. 3C depicts an example tree after a cutting tree operation, in accordance with at least one embodiment of the present invention;

FIG. 3D depicts an example tree after a non-cutting tree operation that removes a shared subtree, in accordance with at least one embodiment of the present invention; and

FIG. 4 is a functional block diagram depicting various components of one embodiment of a computer suitable for executing the methods disclosed herein.

### DETAILED DESCRIPTION

Data may be presented to users as a graph that includes nodes (vertices) representing pieces of information within the data and links (edges) that represent connections between two nodes. When viewing the graph, users may wish to work with (e.g., manipulate) the data presented in the graph. For example, the user may wish to hide (or remove) nodes representing irrelevant or uninteresting data in the graph and then view an updated graph with updated links after the irrelevant or uninteresting nodes have been hidden or removed.

A graph can be represented as a tree, however, a graph may allow a node to have multiple parents, and a tree should not include duplicated information. A tree can represent a graph that contains duplicated data (i.e., a node with two or more parents), by only allowing duplicated data to be present in the tree at a single node (i.e., a developed node), and each duplicated reference to the data is a node (i.e., an undeveloped node) that is a pointer (reference) to the developed node. The concept of an undeveloped node referencing a developed node is referred to as a shared subtree.

Users may use computer based applications to manipulate the data presented in a tree graph (hereinafter tree). The application may allow the users to create filters that identify nodes within the tree that are to be hidden. In some embodiments, the operation of hiding a node within a tree may include removing the targeted node and any offspring nodes that may be reached by passing through the node to be hidden (a cutting operation). In other embodiments, the operation of hiding a node within a tree may remove only the targeted node and connect the immediate offspring of the node to be hidden to the parent of node to be hidden (a non-cutting operation). In some embodiments, a tree operation is identified as a cutting or non-cutting operation within the filter. In other embodiments, business rules and logic are used to determine if the tree operation is a cutting or non-cutting operation.

When removing nodes from a tree, all paths within the tree must remain valid after the node is removed (hidden). When the operation is complete and visually presented to a user, there should be no dangling links (e.g., links connected to nothing on one end after a node has been removed) or orphaned nodes (e.g., nodes that were not removed from the tree, but no longer have a valid path connecting them to the tree). When trees contain shared subtrees, additional care is needed to ensure that all surviving references corresponding to the developed nodes that are the root of a shared subtree and their equivalent undeveloped nodes remain valid.

The embodiments disclosed herein recognize that when hiding nodes in a tree that contains a shared subtree, all paths within the tree must remain valid after the node is hidden. The present invention leverages the above observation and will now be described in detail with reference to the Figures.

It should be noted that references throughout this specification to features, advantages, or similar language herein do not imply that all of the features and advantages that may be realized with the embodiments disclosed herein should be, or are in, any single embodiment of the invention. Rather, language referring to the features and advantages is understood to mean that a specific feature, advantage, or characteristic described in connection with an embodiment is included in at least one embodiment of the present invention. Thus, discussion of the features, advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages will become more fully apparent from the following drawings, description and appended claims, or may be learned by the practice of the invention as set forth hereinafter.

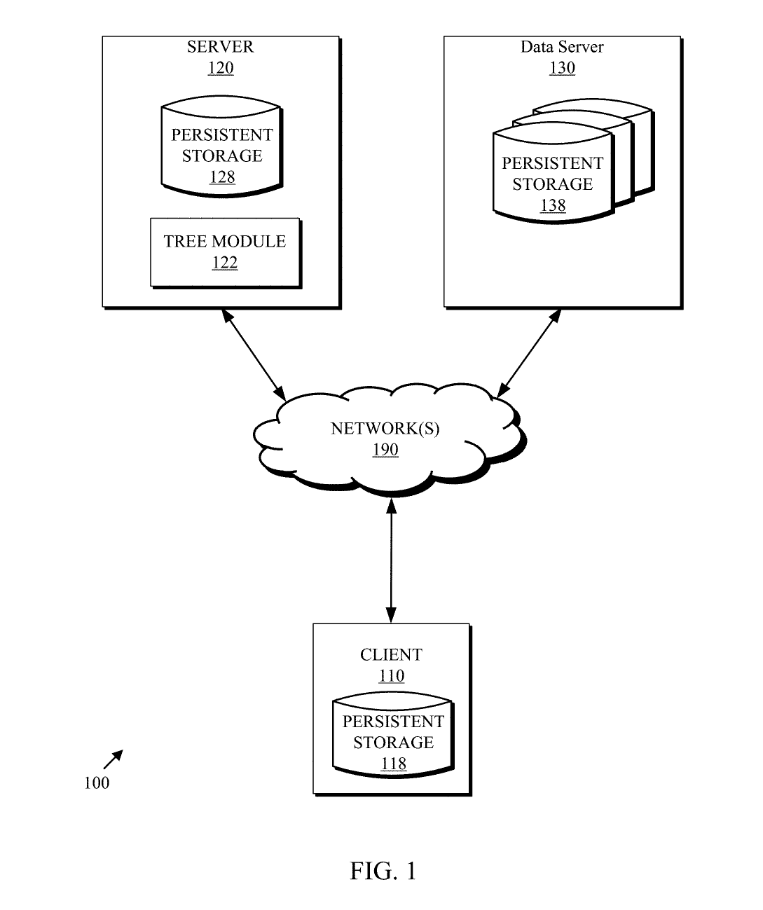

FIG. 1 is a functional block diagram depicting a computing environment 100, in accordance with at least one embodiment of the present invention. Computing environment 100 includes client 110, server 120, and database server 130 that communicate with each other over network(s) 190. As disclosed herein, client 110 is a user device that uses services provided by server 120. Applications and services provided by server 120 may retrieve data from database server 130 over network(s) 190.

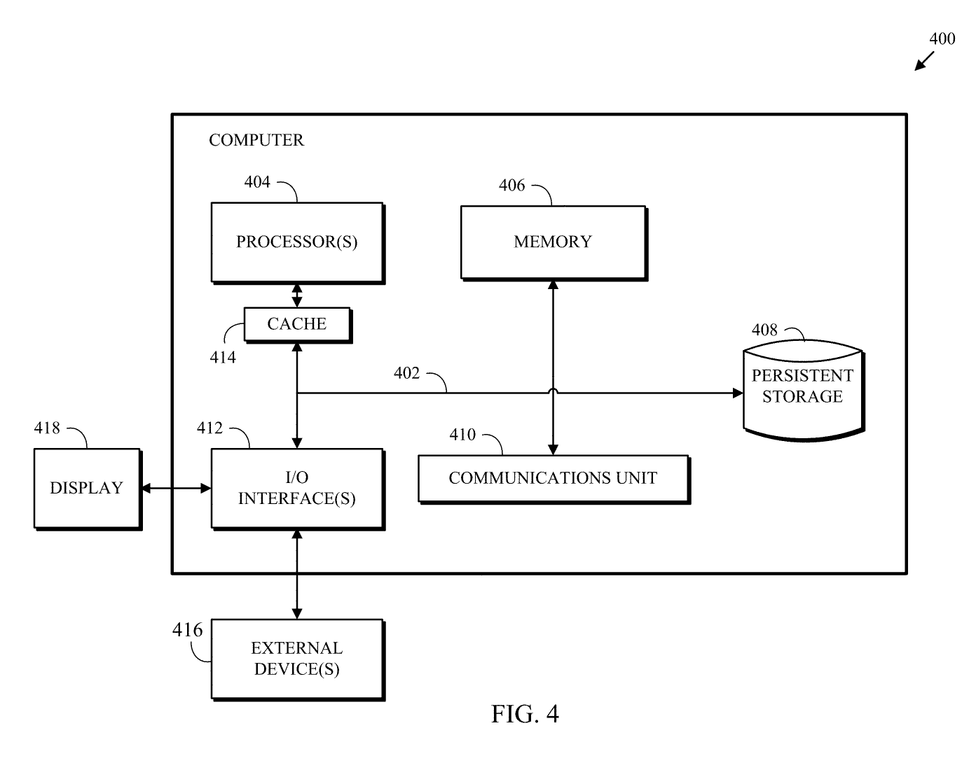

Client 110, server 120, and database server 130 can be computing devices such as smart phones, tablets, desktop computers, laptop computers, specialized computer servers, or the like that are capable of processing instructions and communicating over network(s) 190. In general, client 110, server 120, and database server 130 are representative of any electronic devices, or combination of electronic devices, capable of executing machine-readable program instructions, as described in greater detail with regard to FIG. 4.

As depicted, database server 130 includes persistent storage 138. Database server 130 may include, but is not limited to, a relational database, a database warehouse, or a distributed database. Database server 130 may store data on persistent storage 138.

As depicted, server 120 includes tree module 122 and persistent storage 128. Tree module 122 may be configured to manipulate nodes within a tree. Tree module 122 may enable server 120 to provide a service to client 110 for manipulating data (nodes) within a tree. If the tree contains shared subtrees, tree module 122 may hide a share subtree while maintaining paths between surviving nodes after the shared subtree is hidden. The computer executable instructions that comprise tree module 122 may be stored on persistent storage 128.

Persistent storage 118, 128, and 138 may be any non-volatile storage device or media known in the art. For example, persistent storage 118, 128, and 138 can be implemented with a tape library, optical library, solid state storage, one or more independent hard disk drives, or multiple hard disk drives in a redundant array of independent disks (RAID). Similarly, data on persistent storage 118, 128, and 138 may conform to any suitable storage architecture known in the art, such as a file, a relational database, an object-oriented database, and/or one or more tables.

Tree module 122 may receive tree data that is stored on or retrieved from persistent storage 118, 128, or 138. The tree data may also be stored on or retrieve from cloud storage (not shown). Although tree module 122 is depicted as residing on server 120, tree module 122 may reside on client 110, database server 130, or any other computing device (not shown) that is capable of communicating with client 110 over network(s) 190.

Client 110, server 120, database server 130, and other electronic devices (not shown) communicate over network(s) 190. Network 190 can be, for example, a local area network (LAN), a wide area network (WAN) such as the Internet, or a combination of the two, and include wired, wireless, or fiber optic connections. In general, network(s) 190 can be any combination of connections and protocols that will support communications between client 110, server 120, and database server 130 in accordance with at least one embodiment of the present invention.

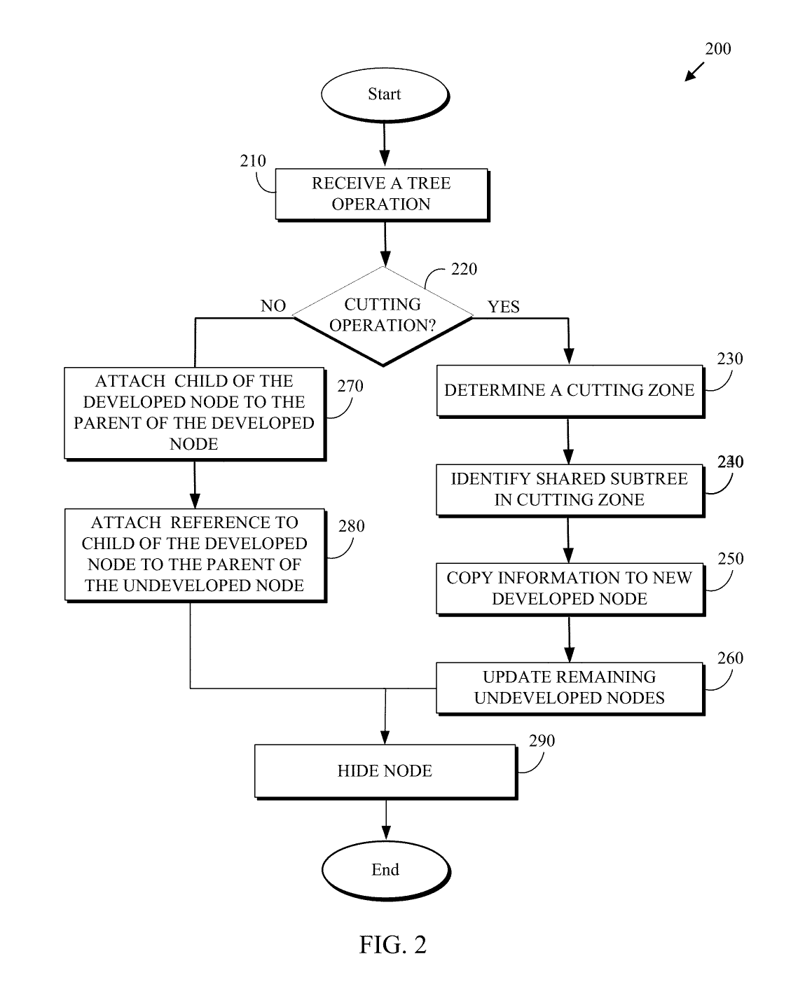

FIG. 2 is a flowchart depicting tree manipulation method 200, in accordance with at least one embodiment of the present invention. As depicted, tree manipulation method 200 includes receiving (210) a tree operation, determining (220) whether an operations is a cutting operation, determining (230) a cutting zone, identifying (240) a shared subtree in the cutting zone, copying (250) information to a new developed node, updating (260) remaining undeveloped nodes, attaching (270) a child to the parent of the developed node, attaching (280) a child reference to the parent of an undeveloped node, and hiding (290) the nodes. Tree manipulation method 200 enables a user to manipulate data represented in a tree containing shared subtrees, and maintain paths between surviving nodes after a shared subtree is hidden.

Receiving (210) a tree operation may include tree module 122 receiving a request from client 110 to manipulate a tree. The tree operation may be received as the result of a user creating a filter to manipulate the data presented in the tree. The tree may include shared subtrees. Some tree operations may result in a node being hidden, and if the hiding operation involves a shared subtree, then the request may require additional processing to assure all paths within the tree remain valid after the operation is complete. Operations that may result in hiding a shared subtree may be, for example, but not limited to, delete a node, move a node, hide a node, etc.

Determining (220) whether an operation is a cutting operation may include tree module 122 determining if the tree operation will hide (or remove) a single node, or the node and all offspring nodes corresponding to the node. A non-cutting operation hides only a target node. A cutting operation includes hiding a target node and any offspring nodes that may be reached by passing through the targeted node. If the operation is a cutting operation, then the depicted method 200 proceeds to determining operation 230. Otherwise, the method proceeds to attaching operation 270.

Determining (230) a cutting zone may include tree module 122 identifying a target node for the tree operation. The cutting zone is the target node and any descendants of the target node. The cutting zone is a collection of nodes that are detached from the tree. The contents of the cutting zone may be identified by traversing the descendants of the target node and identifying nodes that are not already hidden. The cutting zone may contain both developed nodes (i.e., the canonical nodes) and undeveloped nodes (i.e., nodes that reference developed nodes).

Identifying (240) a shared subtree in the cutting zone may include tree module 122 checking each developed node in the cutting zone to determine if the developed node is referenced by undeveloped equivalent nodes. If a developed node is referenced by an (unhidden) undeveloped node, then the developed node is the root of a shared subtree. A shared subtree may comprise a root node with zero or more offspring. In some embodiments, shared subtrees are contained within a single parent tree. In other embodiments, shared subtrees span multiple trees. In some embodiments, a developed node includes a list of corresponding undeveloped equivalent nodes that reference the developed node. In other embodiments, tree module 122 scans the parent tree to identify undeveloped nodes corresponding to a developed node.

Copying (250) information to a new developed node may include tree module 122 identifying an undeveloped node corresponding to the developed node that is going to be hidden, to determine if the undeveloped node will survive the current hiding operation. Surviving the hiding operation is determined by performing an ancestor search (e.g., traversing the ancestors) of the undeveloped node. If the ancestor search results in reaching the root node of the parent tree without passing through a hidden node, then the undeveloped node may survive the hiding operation. In some embodiments, the ancestor search maintains a list of nodes visited to enable detection of a looping situation during the ancestor search. In some embodiments, searching for surviving undeveloped nodes ends as soon as a surviving undeveloped node is identified. In other embodiments, searching for surviving undeveloped nodes continues until all nodes have been searched, and then an optimal surviving node is selected from all identified surviving nodes.

After a surviving undeveloped node is identified, the information (data) from the developed node that is to be hidden is moved to the undeveloped node that will survive the hiding operation. The surviving undeveloped node is now a new developed node. Additionally, if the node to be hidden includes children, the children are attached to the new developed node. Each child and all descendants of the child may be moved under the new dependent node. In some embodiments, the node to be hidden is updated to contain a reference to the new developed node.

Updating (260) remaining undeveloped nodes may include tree module 122 identifying all remaining undeveloped nodes that reference the node that is to be hidden. In some embodiments, the new developed node includes a list that identifies undeveloped nodes that should correspond to the new developed node (e.g., the undeveloped nodes that referenced the node to be hidden). In other embodiments, tree module 122 traverses the parent tree to identify undeveloped nodes that still reference the node to be hidden. Each undeveloped node that is identified is updated to reference the new developed node. After the undeveloped node references are updated, then the depicted method 200 proceeds to hiding operation 290.

Attaching (270) a child to the parent of the developed node may include tree module 122 determining the tree operation is not a cutting operation (i.e., is a non-cutting operation). If the developed node is a child node, then tree module 122 may attach (e.g., move) each child node to the parent of the developed node that is the target of the tree operation (i.e., the child is attached to the grandparent of the child).

Attaching (280) a child reference to the parent of an undeveloped node may include tree module 122 determining that the developed node is a shared subtree with one or more children. Tree module 122 may attach an undeveloped node containing a reference to each child of the developed node (i.e., the developed node that is the target of the tree operation) to the parent of an undeveloped node that is also a target of the tree operation. To clarify, when the root node of a shared subtree is the target of the tree operation (e.g., the root of shared subtree is being removed), then the root of the shared subtree (i.e., the developed node) and all references to the shared subtree (i.e., all undeveloped equivalent nodes) are removed. Since the operation is not a cutting operation, any children of the developed root will survive. Therefore the children of the developed root are moved (attached) to the parent of the developed node, and undeveloped nodes containing references to the surviving children are attached to the parent of each undeveloped equivalent node that references the target of the tree operation.

Hiding (290) the nodes may include tree module 122 hiding (or removing) the node that is the target of the tree operation. Additionally, tree module 122 may determine if the node that is the target of the tree operation is a shared subtree. If the targeted node is a shared subtree, then tree module 122 may additionally hide (or remove) each currently unhidden undeveloped node that references the node that is the target of the tree operation.

In some embodiment, tree module 122 records information in nodes to assist users with identifying the effects of a filter on the data displayed in the tree. For example, a node may be identified as “hiding branches” if at least one child and all the descendants of the node have been hidden (or removed). Additionally, a node may be identified as having a “hidden parent” if the original parent of the node was hidden, causing the node to be attached to the node's grand-parent. The “hiding branches” and “hidden parent” information may appear in a rendered tree as visual aids to assist the user with understanding the effects of a filter on the tree.

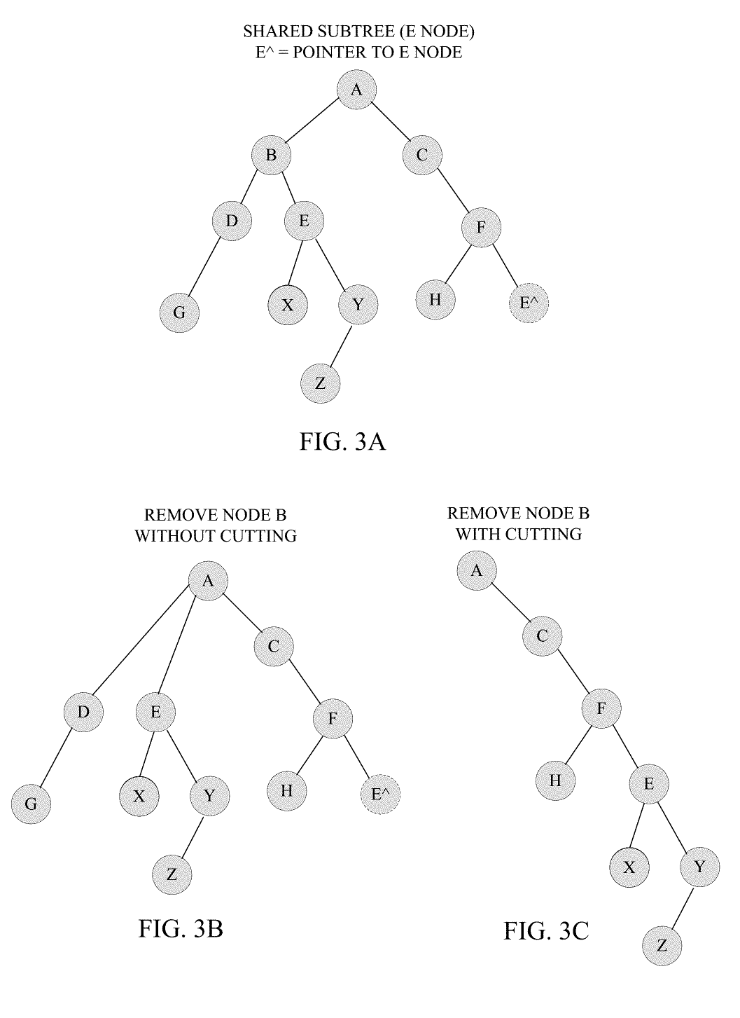

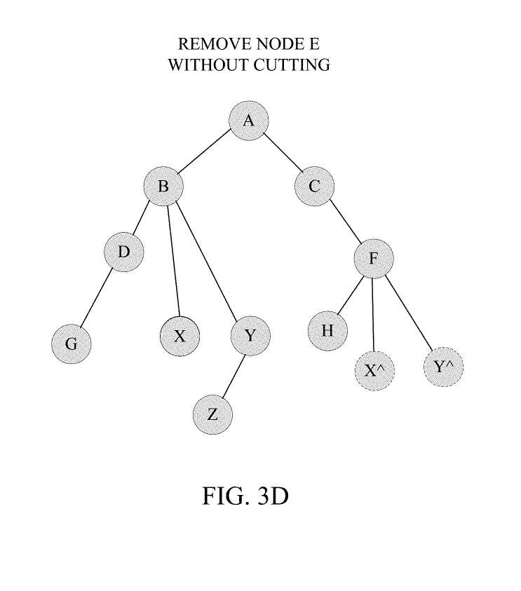

FIG. 3A depicts an example tree with a shared subtree, in accordance with at least one embodiment of the present invention. The depicted example tree includes numerous developed nodes (A, B, C, D, E, F, G, H, X, Y, and Z), and one undeveloped node (Ê). Developed node A is the root of the depicted example tree. Developed node E is a shared subtree that is referenced by undeveloped node Ê. The example tree depicted in FIG. 3A will be the beginning tree for each tree operation depicted in FIGS. 3B-3D.

FIG. 3B depicts an example tree after a non-cutting tree operation, in accordance with at least one embodiment of the present invention. The depicted example shows the resulting tree after a non-cutting operation that removes developed node B from the tree depicted in FIG. 3A. The resulting tree depicts node B removed, and the child of node B (i.e., node E) attached to the parent of node B (i.e., node A). No additional alterations are required to accommodate the (non-cutting) removal of node B from the tree depicted in FIG. 3A. All paths in the resulting tree remain valid, with no orphaned nodes and each branch connected to a node at both ends.

FIG. 3C depicts an example tree after a cutting tree operation, in accordance with at least one embodiment of the present invention. The depicted example shows the resulting tree after a cutting operation that removes developed node B from the tree depicted in FIG. 3A. The resulting tree depicts node B and all nodes that may be reached by passing through node B removed from the tree.

However, node E is a developed node that is a shared subtree comprising nodes E, X, Y, and Z. If nodes E, X, Y, and Z are completely removed from the parent tree, then undeveloped equivalent node Ê would include an invalid reference to a node that would no longer exist. When a cutting operation includes a shared subtree (e.g., node E), and a reference (i.e., undeveloped equivalent node) to the shared subtree will survive the cutting operation (e.g., Ê), then the shared subtree must be moved to the surviving undeveloped equivalent node. As is depicted in FIG. 3C, the subtree with a root of E has been moved to the location in the tree where surviving node Ê was located.

The resulting tree depicts node B and all nodes accessible by passing through node B removed. The shared subtree with node E as the root was moved to the location of surviving undeveloped equivalent node E. Additionally, any additional undeveloped equivalent nodes that reference node E (not shown in this example) would be updated to reference the new developed node E. All paths in the resulting tree remain valid, with no orphaned nodes and each branch connected to a node at both ends.

FIG. 3D depicts an example tree after a non-cutting tree operation that removes a shared subtree, in accordance with at least one embodiment of the present invention. The depicted example shows the resulting tree after a non-cutting tree operation that removes developed node E (the root of a shared subtree) from the tree depicted in FIG. 3A. The resulting tree depicts node E removed, and the children of node E (i.e., nodes X and Y) attached to the parent of node E (i.e., node B).

Additionally, when the root of a shared subtree is the object of a tree operation, the tree operation occurs on the developed node (i.e., node E), and each undeveloped equivalent node (e.g., node Ê) in the tree. Since node E was removed, then node Ê will also be removed. However, after node E was removed, the children of node E were attached to the parent of node E. Similarly, when node Ê is removed, a reference to each of the children of node E is attached to the parent of node Ê (i.e., nodes X̂ and Ŷ are attached to node F).

The resulting tree depicts nodes E and Ê removed. The children of node E (i.e., nodes X and Y) are attached to the parent of node E (i.e., node B). Additionally, references to the children of node E (i.e., X̂ and Ŷ) are attached to the parent of node Ê (i.e., node F). All paths in the resulting tree remain valid, with no orphaned nodes and each branch connected to a node at both ends.

FIG. 4 depicts a functional block diagram of components of a computer system 400, which is an example of systems such as client 110, server 120, and database server 130 within computing environment 100 of FIG. 1, in accordance with at least one embodiment of the present invention. It should be appreciated that FIG. 4 provides only an illustration of one implementation and does not imply any limitations with regard to the environments in which different embodiments can be implemented. Many modifications to the depicted environment can be made.

Client 110, server 120, and database server 130 include processor(s) 404, cache 414, memory 406, persistent storage 408, communications unit 410, input/output (I/O) interface(s) 412 and communications fabric 402. Communications fabric 402 provides communications between cache 414, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM). In general, memory 406 can include any suitable volatile or non-volatile computer readable storage media. Cache 414 is a fast memory that enhances the performance of processor(s) 404 by holding recently accessed data, and data near recently accessed data, from memory 406.

Program instructions and data used to practice embodiments of the present invention, e.g., tree manipulation method 200, are stored in persistent storage 408 for execution and/or access by one or more of the respective processor(s) 404 via cache 414. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including resources of client 110, server 120, and database server 130. In these examples, communications unit 410 includes one or more network interface cards. Communications unit 410 may provide communications through the use of either or both physical and wireless communications links. Program instructions and data used to practice embodiments of tree manipulation method 200 may be downloaded to persistent storage 408 through communications unit 410.

I/O interface(s) 412 allows for input and output of data with other devices that may be connected to each computer system. For example, I/O interface(s) 412 may provide a connection to external device(s) 416 such as a keyboard, a keypad, a touch screen, a microphone, a digital camera, and/or some other suitable input device. External device(s) 416 can also include portable computer readable storage media such as, for example, thumb drives, portable optical or magnetic disks, and memory cards. Software and data used to practice embodiments of the present invention can be stored on such portable computer readable storage media and can be loaded onto persistent storage 408 via I/O interface(s) 412. I/O interface(s) 412 also connect to a display 418.

Display 418 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method executed by one or more processors, the method comprising:
receiving a tree graph operation;
determining whether the tree graph operation is a cutting operation;
responsive to determining that the tree graph operation is the cutting operation:
determining a cutting zone for the cutting operation, and
identifying a developed node in the cutting zone that is to be retained in a tree graph subsequent to the cutting operation, wherein the developed node is a root node of a shared subtree;
responsive to determining that the tree graph operation is not the cutting operation:
attaching each child of the developed node to a parent of the developed node, and
attaching a reference to each child of the developed node to a parent of remaining undeveloped nodes, responsive to determining the developed node is a shared subtree with one or more children; and
hiding each node of the tree graph that is to be hidden.

2. The method of claim 1, wherein identifying the developed node in the cutting zone that is to be retained in the tree graph comprises identifying an undeveloped node that is equivalent to the developed node, copying information within the developed node to the undeveloped node to provide a new developed node, identifying the remaining undeveloped nodes that are equivalent to the developed node, and updating the remaining undeveloped nodes to reference the new developed node.

3. The method of claim 2, further comprising moving a subtree corresponding to the developed node to the new developed node.

4. The method of claim 2, further comprising determining whether the undeveloped node is to be retained in the tree graph subsequent to the cutting operation.

5. The method of claim 1, wherein the tree graph comprises one or more shared subtrees.

6. The method of claim 1, wherein the shared subtree is included in one or more tree graphs.

7. The method of claim 1, wherein the tree graph operation is selected from a group consisting of a hide operation, a delete operation, or a move operation.

8. A computer program product comprising:
one or more computer readable storage media and program instructions stored on the one or more computer readable storage media, the program instructions comprising instructions executable by a computer to perform:
receiving a tree graph operation;
determining whether the tree graph operation is a cutting operation;
responsive to determining that the tree graph operation is the cutting operation:
determining a cutting zone for the cutting operation, and
identifying a developed node in the cutting zone that is to be retained in a tree graph subsequent to the cutting operation, wherein the developed node is a root node of a shared subtree;
responsive to determining that the tree graph operation is not the cutting operation:
attaching each child of the developed node to a parent of the developed node, and
attaching a reference to each child of the developed node to a parent of remaining undeveloped nodes, responsive to determining the developed node is a shared subtree with one or more children; and
hiding each node of the tree graph that is to be hidden.

9. The computer program product of claim 8, wherein the program instructions for identifying the developed node in the cutting zone that is to be retained in the tree graph include instructions for identifying an undeveloped node that is equivalent to the developed node, copying information within the developed node to the undeveloped node to provide a new developed node, identifying the remaining undeveloped nodes that are equivalent to the developed node, and updating the remaining undeveloped nodes to reference the new developed node.

10. The computer program product of claim 9, wherein the program instructions include instructions for moving a subtree corresponding to the developed node to the new developed node.

11. The computer program product of claim 9, wherein the program instructions include instructions for determining whether the undeveloped node is to be retained in the tree graph subsequent to the cutting operation.

12. The computer program product of claim 8, wherein the tree graph comprises one or more shared subtrees.

13. The computer program product of claim 8, wherein wherein the shared subtree is included in one or more tree graphs.

14. The computer program product of claim 8, wherein the tree graph operation is selected from a group consisting of a hide operation, a delete operation, or a move operation.

15. A computer system comprising:
one or more computer processors;
one or more computer readable storage media;
program instructions stored on the computer readable storage media for execution by at least one of the computer processors, the program instructions comprising instructions to perform:
receiving a tree graph operation;
determining whether the tree graph operation is a cutting operation;
responsive to determining that the tree graph operation is the cutting operation:
determining a cutting zone for the cutting operation, and
identifying a developed node in the cutting zone that is to be retained in a tree graph subsequent to the cutting operation, wherein the developed node is a root node of a shared subtree;
responsive to determining that the tree graph operation is not the cutting operation:
attaching each child of the developed node to a parent of the developed node, and
attaching a reference to each child of the developed node to a parent of remaining undeveloped nodes, responsive to determining the developed node is a shared subtree with one or more children; and
hiding each node of the tree graph that is to be hidden.

16. The computer system of claim 15, wherein the program instructions for identifying the developed node in the cutting zone that is to be retained in the tree graph include the instructions for identifying an undeveloped node that is equivalent to the developed node, copying information within the developed node to the undeveloped node to provide a new developed node, identifying the remaining undeveloped nodes that are equivalent to the developed node, and updating the remaining undeveloped nodes to reference the new developed node.

17. The computer system of claim 16, wherein the program instructions include the instructions for moving a subtree corresponding to the developed node to the new developed node.

18. The computer system of claim 16, wherein the program instructions include the instructions for determining whether the undeveloped node is to be retained in the tree graph subsequent to the cutting operation.

19. The computer system of claim 15, wherein wherein the shared subtree is included in one or more tree graphs.

20. The computer system of claim 15, wherein the tree graph operation is selected from a group consisting of a hide operation, a delete operation, or a move operation.
